(19) United States
(12) Patent Application Publication
(10) Pub. No.: US 2025/0371032 A1
(43) Pub. Date: Dec. 4, 2025

(54) SYSTEMS AND METHODS FOR PREVENTING SPLITS OF RELATED DATA IN A DISTRIBUTED DATABASE

(71) Applicant: Google LLC, Mountain View, CA (US)

(72) Inventors: Mike Hom, Arlington, VA (US); David Slater, New York, NY (US); Borja Zarco, Fort Lee, NJ (US); Travis Lanham, Sunnyvale, CA (US); Chinmaya Manjunath, San Jose, CA (US); Gianluca Borello, Sunnyvale, CA (US)

(21) Appl. No.: 19/220,720

(22) Filed: May 28, 2025

Related U.S. Application Data
(60) Provisional application No. 63/654,614, filed on May 31, 2024.

(51) Int. Cl. G06F 16/27; G06F 16/22; G06F 16/23

(52) U.S. Cl. CPC G06F 16/278; G06F 16/2282; G06F 16/2358

(57) ABSTRACT

A method includes receiving, by a security analytics platform, first data associated with a computing resource, storing the first data in a first database table associated with the computing resource, and generating a first set of indicators associated with the first database table. Each indicator of the first set of indicators identifies a corresponding horizontal partition associated with the first database table. The method further includes receiving second data associated with the computing resource, storing the second data in a second database table associated with the first database table, and generating a second set of indicators associated with the second database table. The method further includes storing, based on the first and second set of indicators, a first partition of the first database table and a corresponding partition of the second database table, on a same database node.

### RELATED APPLICATION

This application claims the benefit of U.S. Provisional Application No. 63/654,614, filed May 31, 2024, the entire content of which is hereby incorporated by reference.

### TECHNICAL FIELD

Aspects and implementations of the present disclosure relate to computer security, and in particular to preventing splits of related data in a distributed database.

### BACKGROUND

Computing devices such as data centers and cloud computing platforms can be susceptible to malicious activity (e.g., malware, network-based attacks). Malicious activity can lead to interruption or inefficient operation of computing devices, which can be problematic for owners and operators of computing devices. In extreme cases, malicious activity can damage computing devices or data stored thereon, potentially causing substantial financial loss and other losses and liabilities for the owners and operators of computing devices.

Security analytics platforms may have malicious activity notification mechanisms in place that alert clients when potential malicious activity is detected. The malicious activity can then be mitigated, e.g., by blocking a malicious file from being downloaded, stopping malicious processes that are running, etc.

### SUMMARY

The following presents a simplified summary of various aspects of this disclosure in order to provide a basic understanding of such aspects. This summary is not an extensive overview of all contemplated aspects, and is intended to neither identify key or critical elements nor delineate the scope of such aspects. Its purpose is to present some concepts of this disclosure in a simplified form as a prelude to the more detailed description that is presented later.

An aspect of the disclosure provides a computer-implemented method which includes receiving, by a security analytics platform, first data associated with a computing resource, storing the first data in a first database table associated with the computing resource, and generating a first set of indicators associated with the first database table. Each indicator of the first set of indicators identifies a corresponding horizontal partition associated with the first database table. The method further includes receiving second data associated with the computing resource, storing the second data in a second database table associated with the first database table, and generating a second set of indicators associated with the second database table. Each indicator of the second set of indicators specifies a corresponding horizontal partition associated with the second database table. The method further includes storing, based on the first set of indicators and the second set of indicators, a first partition of the first database table and a corresponding partition of the second database table, on a same database node.

A further aspect of the disclosure provides a system comprising: a memory; and a processing device, coupled to the memory, the processing device to perform a method according to any aspect or implementation described herein.

A further aspect of the disclosure provides a non-transitory computer-readable medium comprising instructions that, responsive to execution by a processing device, cause the processing device to perform operations according to any aspect or implementation described herein.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example of system architecture, in accordance with implementations of the disclosure.

FIG. 2 schematically illustrates an example data table maintained by a data store, in accordance with aspects of the present disclosure.

FIG. 3 depicts a flow diagram of an example method for embedding horizontal partition boundaries in a data table, in accordance with implementations of the present disclosure.

FIG. 4 depicts a flow diagram of an example method for performing a horizontal partition of a data table, in accordance with implementations of the present disclosure.

FIG. 5 depicts a block diagram of an example computing device operating in accordance with one or more aspects of the present disclosure, in accordance with implementations of the present disclosure.

### DETAILED DESCRIPTION

A security analytics platform can ingest data from computing resources (e.g., computing systems) of a platform customer in order to detect and respond to security threats on those computing resources. The ingested data (referred to as “security data”) can include, e.g., telemetry data (e.g., log files produced by the operating systems, middleware, and/or applications), contextual data (background data that gives a broader understanding of the telemetry data, such as, for example, network activity metadata, data related to current and/or past threats, data related to file hashes, data related to domains, and other data related to the customer's organization), and/or change log data (e.g., upgrades, downgrades, enhancements, bug fixes, modifications, deprecations, etc.). The security analytics platform can combine the ingested security data with the platform-provided data (e.g., platform proprietary data, open-source data, other publicly available data, etc.) and analyze the combined data to identify patterns or anomalies that indicate a security threat for the computing resource.

A data processing pipeline can store the security data in a distributed database for further processing and querying. The distributed database can include one or more rectangular tables, such that each row of a table corresponds to a single record and each column corresponds to a field of the record. A chosen column of the table can be defined as the table's primary key, which uniquely identifies each row, e.g., for updating or deleting operations. Primary keys can be indexed for quick row lookup, and secondary indexes can be defined on one or more other columns.

A distributed database can correlate (e.g., link to one another) records of two or more tables by establishing parent-child table relationships. In particular, the parent table can contain a column designated as the primary key while the child table can contain one or more columns designated as respective foreign keys. A foreign key value can be matched to a primary key of the parent table. In other instances, other correlation means can be used, such as timestamps. For example, one or more records of one table can be correlated to one or more records of another table based on the respective timestamp values falling within a specified time window. Thus, a data locality relationship exists between the two tables, which improves access efficiency of the database. Hierarchies of interleaved parent-child relationships may be multiple layers deep, such as a child table may have its own child table, and so forth.

To balance the workload across multiple nodes as the database grows, the tables of the distributed database can be horizontally partitioned (“sharded”) between two or more physical or virtual nodes of the system. Each partition (“shard”) can hold a range of contiguous rows on respective one or more nodes (e.g., servers, virtual machines, etc.). Such horizontal partitioning would allow linear scaling by adding nodes as the size of the database increases.

To split the tables in a distributed database, an indicator referred to as a “split boundary” identifies a location between two rows to split the database, and one or more tables stored on the database are split along the split boundary. The location of the split can be selected to split the tables into K roughly equal parts (e.g., approximately the same number of rows will be stored on each node after the split).

However, such a partitioning technique system might fail to account for specific relationships between data when generating the split boundaries, which can lead to separating child table data from the related parent table data. This causes increased latency when querying the distributed database since the security analytics platform now queries to multiple nodes to obtain the desired data.

Aspects of the present disclosure relate to an improved performance of security analytics platforms. In particular, the aspects of the present disclosure enable a platform to embed shard indicators (referred to as “horizontal partition boundaries”) in the data tables generated to store consumer data. The horizontal partition boundaries can be used to guide a distributed database to where to split the tables such that splits between payload data and its corresponding change log data are prevented. In some implementations, the horizontal partition boundaries can be specified by values of a special metadata column maintained in each table, such that a first metadata value (e.g., 0) would indicate that the current row needs to be kept with the next one, while a second metadata value (e.g., 1) would indicate that the table can be split after the current row. Thus, to perform horizontal partitioning of the table, the database engine partitions the database (e.g., one or more tables of the database) according to the split metadata. This approach enables the parent data row and its corresponding child data rows to remain on the same node (e.g., payload data and change log data).

Aspects of the present disclosure result in improved performance of security analytics platforms. In particular, the aspects of the present disclosure prevent splitting related data during horizontal partitions of a regional database. This results in a decreased latency when querying the distributed database since a security analytics platform only needs to query a single node to obtain the desired data (e.g., the payload data and its corresponding change log data). Thus, considerable time and computing resources are saved.

Implementations of the present disclosure may be discussed with reference to payload data (e.g., telemetry data and contextual data) and its corresponding change log data. However, it is noted that implementations of the present disclosure can be used with any type of sets of data that a user desires to remain on the same node after a horizontal partition. Further, implementations of the present disclosure may be discussed with reference to horizontal partitioning. However, it is noted that implementations of the present disclosure can be used with other types of partitioning, such as, for example, vertical partition.

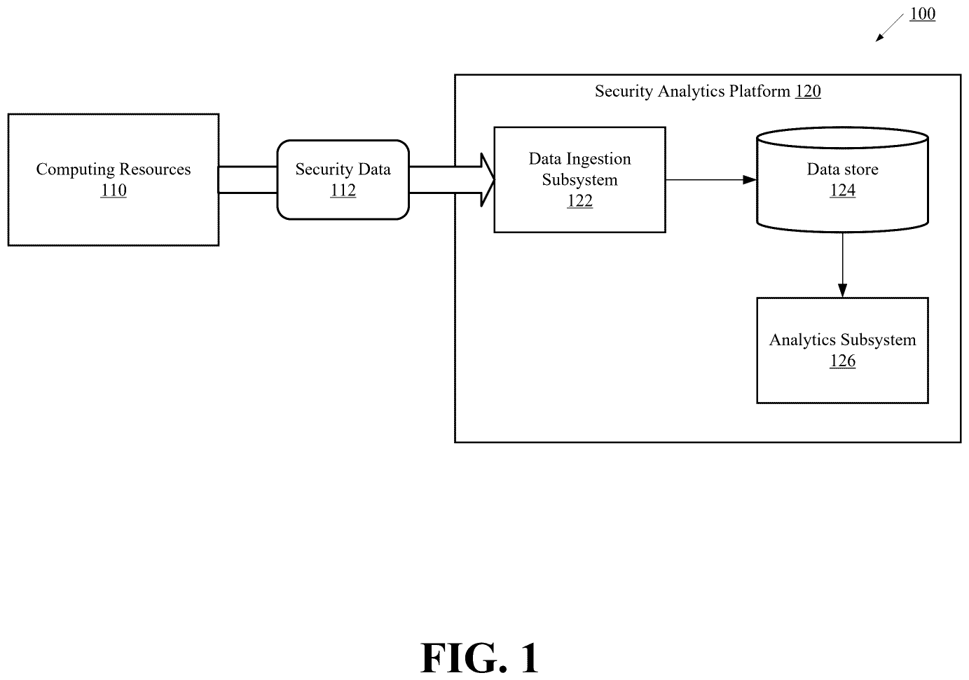

FIG. 1 illustrates an example system architecture 100 for preventing related data splits by a distributed database, in accordance with implementations of the present disclosure. The system architecture 100 (also referred to as “system” herein) includes computing resources 110 and security analytics platform 120. Computing resources 110 can provide various types of security data 112 to security analytics platform 120. Security data 112 can include telemetry data, contextual data, and/or change log data. Telemetry data can include log files produced by the operating systems, middleware, and/or applications that reflect metrics, measurements, events, etc. pertaining to computing resources 110 and/or corresponding software. Contextual data can include background data that gives a broader understanding of the telemetry data, such as, for example, network activity metadata, data related to current and/or past threats, data related to file hashes, data related to domains, and other data related to the customer's organization. Change log data can include upgrades, downgrades, enhancements, bug fixes, modifications, deprecations, etc. related to the telemetry data, contextual data, computing resources 110 and/or corresponding software. The security analytics platform 120 can include data ingestion subsystem 122, data store 124, and analytics subsystem 126.

In some implementations, computing resources 110 includes a computing system operated by a user (e.g., a customer) of the entity that operates the security analytics platform 120 and provides security analytics services to the customer. In certain implementations, computing resources 110 can include multiple computing systems, each operated by one or more users. Computing resources 110 can include one or more servers. A server can include a computing device. In some implementations, a computing device includes a physical computing device or includes a virtualized component, such as a virtual machine (VM) or a container. A computing device can include an instance of a computing device. An instance of a computing device can include a spun-up instance that cannot be specific to any computing device. In some implementations, a VM can include a system virtual machine, which can include a VM that emulates an entire physical computing device. A VM can include a process virtual machine, which can include a VM that emulates an application or some other software. A container can include a computing environment that logically surrounds one or more software applications independently of other applications executing on the computing resources 110.

The computing resources 110 can include one or more network devices. A network device can include a switch, router, hub, gateway, wireless access point, bridge, modem, repeater, or another type of network device. A network device can help provide data communication between the one or more servers, between other devices of the computing resources 110, or between a computing device external to the computing resources 110 and a device of the computing resources 110. The computing resources 110 can include one or more data storage devices. A data storage device can include a data store. One or more servers or other computing devices of the computing resources 110 can store data on the one or more data storage devices or retrieve data from the one or more data storage devices.

In some implementations, the computing resources 110 and the security analytics platform 120 are in data communication with each other over a data network. The data network can include a local area network (LAN), wide area network (WAN), a virtual private network (VPN), or some other data network. The data network can include network devices, including switches, routers, hubs, gateways, wireless access points, bridges, modems, repeaters, or other network devices.

In some implementations, the computing resources 110 and the security analytics platform 120 can execute on different computing systems. In other implementations, at least a portion of the computing resources 110 and the security analytics platform 120 can execute on the same computing system. The computing system can include a cloud computing system. A cloud computing system can include one or more computing devices (or portions of cloud computing devices) provided to an end user by a cloud provider. An end user of the environment can utilize a portion of the cloud computing system to host content for use or access by other parties or perform other computational tasks. In some implementations, the cloud computing system can be configured to allow the end user to use a portion of a computing device (e.g., only certain hardware, software, or other computer system resources). The cloud computing environment can include a private cloud, a public cloud, or a hybrid cloud. The cloud computing environment can provide infrastructure-as-a-service (IaaS), platform-as-a-service (PaaS), or software-as-a-service (SaaS) computing. The cloud computing environment can provide serverless computing.

In some implementations, security data 112 provided by the computing resources 110 includes one or more event logs reflecting telemetry data, contextual data, and/or change log data. An event log can include a data record that represents an event related to a device or software of the computing resources 110. A device (including a component of a device) can generate the event log, or software can generate the event log. The event log can include data about the event represented by the event log. In some implementations, an event log includes a structured event log. A structured event log can include event data in a structured format. Event data in a structured format can include data that is organized into a recognized format. The structured event log can include event data in a Javascript Object Notation (JSON) format, an Extensible Mark-up Language (XML) format, a comma-separated values (CSV) format, or event data in some other structured format.

In some implementations, the security analytics platform 120 is a computing platform configured to obtain security data 112 from the computing resources 110 and analyze the security data in order to detect and respond to security threats on the computing resources 110. The security analytics platform 120 can include a cloud computing system.

In some implementations of the disclosure, a “user” can be represented as a single individual. However, other implementations of the disclosure encompass a “user” being an entity controlled by a set of users or an organization and/or an automated source such as a system or a platform. In situations in which the systems discussed here collect personal information about users, or can make use of personal information, the users can be provided with an opportunity to control whether the security analytics platform 120 collects user information (e.g., information about a user's social network, social actions or activities, profession, a user's preferences, or a user's current location), or to control whether and/or how to receive content from the security analytics platform 120 that can be more relevant to the user. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the security analytics platform 120.

In some implementations, the data ingestion subsystem 122 includes software configured to obtain data 112 from the computing resources 110, convert at least a portion of the security data 112 to a standardized format used by the security analytics platform 120, and store the data in the standardized format in the data storage 124. Because different portions of the security data 112 can be in different formats, the data ingestion subsystem 122 can convert the security data 112 into a standardized format used by the platform 120 so the platform 120 can efficiently analyze the converted security data 112.

The standardized format can include one or more key-value pairs. A key can include data that indicates a category of data, and the corresponding value can include data that belongs to that category. More specifically, a key can refer to an attribute or a set of attributes used to identify a row (or tuple) uniquely in a table (or relation). The key can be used to establish relationships between the different columns, rows, and/or tables of a data store 124. Keys can include primary keys (used to uniquely identify each record in a table), candidate keys (alternative unique keys that could be used as primary keys), super keys (a collection of keys used to recognize every row in the table), foreign keys (used to establishes a relationship between tables), alternate keys (a key that has the potential to replace the primary key but is not yet the primary key), compound keys (a set of combined attributes used as a single key), surrogate keys (artificial keys assigned for record identification) and so forth. The value can be any user data, such as, for example, telemetry data, contextual data, change log data, modified data (any ingested data that is converted, formatted, altered, enriched, etc.), etc.

In some implementations, the data ingestion subsystem 122 can perform one or more data enrichment operations to generate or modify security data 112. For example, the data ingestion subsystem 122 can convert security data 112 from the computing resources 110 into a key-value pair, and the data ingestion subsystem 122 can then enrich data 112 by adding, for example, platform-provided data. The platform-provided data can include platform proprietary data, open-source data, other publicly available data, etc. In some implementations, the data ingestion subsystem 122 does not convert at least a portion of the security data 112 to a standardized format used by the platform 120 and can use the portion of the security data 112, in its original format, as one or more key-value pairs. In some implementations, the data enrichment can be performed by analytics subsystem 126.

In some implementations, the data ingestion subsystem 122 can store one or more key-value pairs in the data storage 124. Data store 124 can include a physical storage medium that can include volatile storage (e.g., random access memory (RAM), etc.) or non-volatile storage (e.g., a hard disk drive (HDD), flash memory, etc.). Data store 124 can include a file system, a database (an object-oriented database, a relational database, a distributed database, etc.), or some other software configured to store data.

In some implementations, data store 124 can include a distributed database. A distributed database is a database that runs and stores data across multiple computer systems, as opposed to on a single computer system. Distributed databases can operate on two or more interconnected servers (referred to as “nodes”) on a computer network. Each distributed database can include one or more rectangular tables, such that each row of a table corresponds to a single record and each column corresponds to a field of the record. A chosen column of the table can be defined as the table's primary key, which uniquely identifies each row, e.g., for updating or deleting operations. For example, a column can be defined by a table's primary key (generated by data ingestion subsystem 122), which uniquely identifies each row. Primary keys can be indexed for quick row lookup, and secondary indexes can be defined on one or more other columns. The primary keys can be used to identify rows, e.g., for updating or deleting operations. Although table (e.g., database table) will be discussed herein by way of illustrative example, it is noted that data store 124 can store any data object (e.g., an in-memory data structure, a file, a database table, etc.) and aspects of the present disclosure can be implemented using any type, or combination of, these data objects.

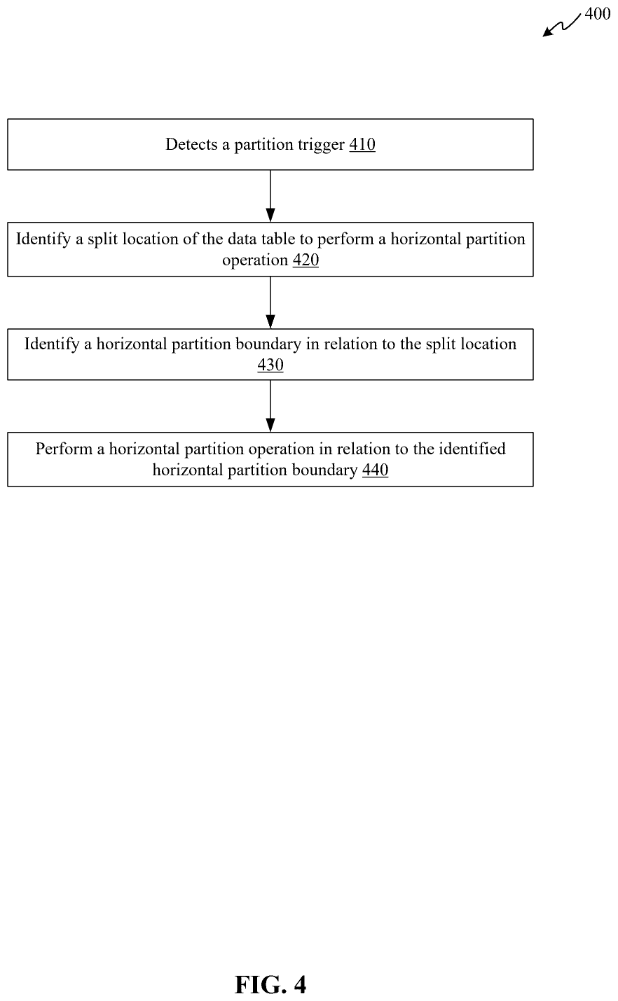

To balance the workload across multiple nodes as the database grows, data store 124 can horizontally partition (“shard”) the tables of the distributed database between two or more nodes. Each shard can hold a range of contiguous rows on respective nodes. More specifically, as the table(s) of data store 124 grow, data store 124 can perform sharding operations (via, for example, a database engine, not shown) to distribute (or attempt to distribute) data across multiple nodes evenly (e.g., distribute a similar number of rows per node). However, in certain instances, as the table grows, the distribution can become uneven such that a node can be overloaded with data while other nodes manage a stagnant or insignificant increased amount of data. Accordingly, the sharding operations can include re-distributing the data of the overloaded node between the existing nodes or adding a new node and split the overloaded node into two nodes. Sharding operations will be discussed in greater detail below with regards to FIG. 4.

In some implementations, data ingestion subsystem 122 can embed, into the data tables of data store 124, one or more horizontal partition boundaries. These horizontal plane boundaries can be used to guide data store 124 as to where to split rows (or tables) during a horizontal partition such that splits between certain types of data is prevented. In some implementations, the horizontal partition boundaries can be used to prevent splits between payload data (e.g., telemetry data and contextual data) and its corresponding change log data.

In some implementations, via data ingestion subsystem 122, the horizontal partition boundaries can be specified by values of a special metadata column maintained in the table. In one illustrative example, a first metadata value (e.g., 0) would indicate that the current row needs to be kept with the next one, while a second metadata value (e.g., 1) would indicate that the table can be split after the current row. In another illustrative example, a first metadata value (e.g., 1) would indicate that the table can be split above the current row current, while a second metadata value (e.g., 0) would indicate that the current row needs to be kept with the previous one. Thus, in order to perform horizontal partitioning of the table, the database engine partition the table according to the split metadata.

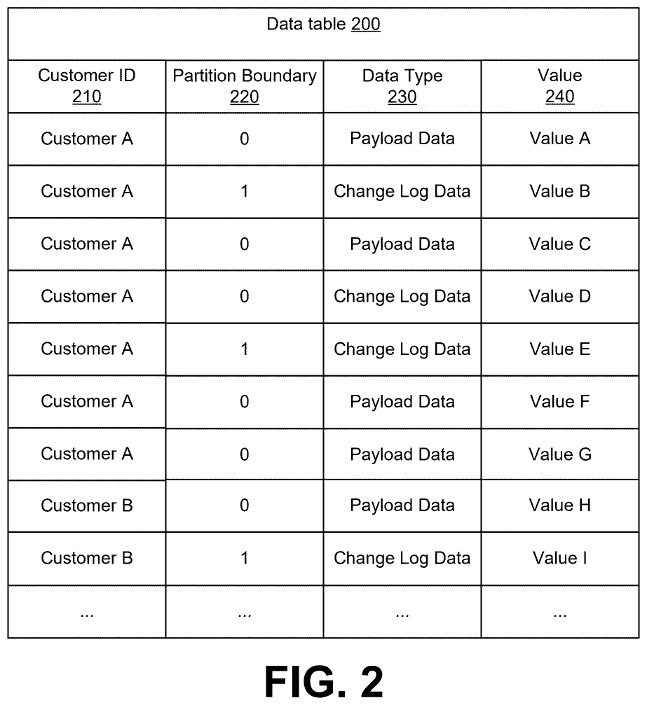

FIG. 2 schematically illustrates an example data table 200 maintained by data store 124, in accordance with aspects of the present disclosure. Data table 200 includes a column for storing a customer IDs 210, a column for storing the partitioning metadata 220, a column for storing a data type 230, and a column for storing a value 240. The values stored in the customer ID column 210 can be indicative of which customer (e.g., operator of a computing resource) the corresponding data belongs. For example, data table 200 shows two customers: Customer A and Customer B. In some implementations, the customer ID can be a primary key. The cells of horizontal partition boundary column 220 can maintain special metadata used by data store 124 as a guide to split the rows of data table 200 during a horizontal partition such that splits between payload data and corresponding change log data are prevented. In the example shown by data table 200, the value 0 can indicate to data store 124 that the current row needs to be kept with the next one, while the value 1 can indicate to data store 124 that a split can be performed after the current row. The cells of data type column 230 can store indicators referencing the type of data stored in the subsequent value cell. For example, data table 200 shows that the data types can include payload data and change log data. The cells of value column 240 can store certain data identified by the column cell of each respective row. The data stored in the cells of column 240 (indicated by Value A-Value I) can include security data such as payload data or change log data.

The value of the horizontal partition boundary can be set in relation to, for example, the datatype of the corresponding row. For example, a new payload data row can have its partition boundary set to a value of 1, which indicates that the table can be split above the current row. Once a corresponding change log data row is added, the horizontal partition boundary value of the payload data row can be reset to 0 (which indicates that the current row needs to be kept with the next one), while the horizontal partition boundary value of the change log data row can be set to a value of 1. This dynamic changing of horizontal partition boundaries keeps new change log data tables with their related payload data table. In each instance that an additional change log data row is added, the horizontal partition boundary value related to the newest change log data can be set to a value of 1, while the horizontal partition boundary value(s) of the previous change log data rows can be set to a value of 0.

In some implementations, horizontal partitioning of the data store 124 may involve identifying a horizontal partition boundary 220, and use the horizontal partition boundaries to guide which rows of data table 200 to split (e.g., perform a split operation above the horizontal partition boundary). This enables the payload data row and its corresponding change log data row(s) to remain on the same node after the partition. It is noted that performing the split operation above the horizontal partition boundary is used by way of illustrative example, and that the horizontal partition boundaries can be indicative of other locations to perform the split operation (e.g., perform the split operation at the horizontal partition boundary, below the horizontal partition boundary, etc.).

Returning to FIG. 1, In some implementations, a single payload data table can store payload data for different payload events. As such, data records between two tables can be correlated using, for example, their respective timestamps. In particular, for each payload event, the relevant change log data can span over the time window of a predefined duration starting from the time of the payload event. Thus, as new data is recorded to a change log table (additional records are added), the horizontal partition boundaries can be added or existing horizontal partition boundaries can be modified to correlate all of the new records of the change log table with the specified one or more records of the payload table.

The analytics subsystem 126 can include one or more computing devices (such as a rackmount server, a router computer, a server computer, a personal computer, a mainframe computer, a laptop computer, a tablet computer, a desktop computer, etc.), data structures (e.g., hard disks, memories, databases), networks, software components, or hardware components that can be used to provide a user with access to data or services. Such computing devices can be positioned in a single location or can be distributed among many different geographical locations. For example, analytics subsystem 126 can include a plurality of computing devices that together may comprise a hosted computing resource, a grid computing resource, or any other distributed computing arrangement. In some implementations, analytics subsystem 126 can correspond to an elastic computing resource where the allotted capacity of processing, network, storage, or other computing-related resources may vary over time.

Analytics subsystem 126 can be configured to collect, analyze, and respond to security data retrieved (or received) from analytics subsystem 126. For example, analytics subsystem can obtain the security data from data store 124 (e.g., collect event logs reflecting payload data and change log data). Analytics subsystem 126 can then provide computing resources 110 with tools to analyze the queried data. In some implementations, one or more aspects of the tools to analyze the queried data can be automated or partially automated. Analytics subsystem 126 can provide computing resources 110 with tools to perform one or more actions based on information obtained from the queried data.

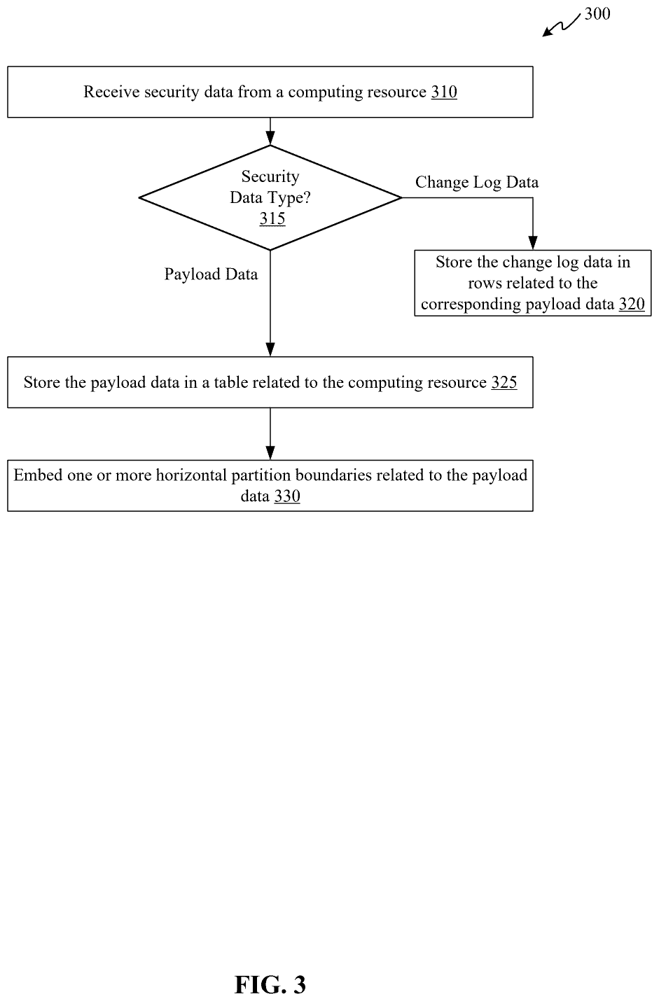

FIG. 3 depicts a flow diagram of an example method 300 for embedding horizontal partition boundaries in a data table, in accordance with implementations of the present disclosure. Method 300 can be performed by processing logic that can include hardware (circuitry, dedicated logic, etc.), software (e.g., instructions run on a processing device), or a combination thereof. In one implementation, some or all of the operations of method 300 can be performed by one or more components of system 100 of FIG. 1. In some implementations, some or all of the operations of method 300 can be performed by data ingestion subsystem 122, as described above.

For simplicity of explanation, method 300, as well as any other method of this disclosure, is depicted and described as a series of acts. However, acts in accordance with this disclosure can occur in various orders and/or concurrently, and with other acts not presented and described herein. Furthermore, not all illustrated acts may be required to implement method 300 in accordance with the disclosed subject matter. In addition, those skilled in the art will understand and appreciate that method 300 could alternatively be represented as a series of interrelated states via a state diagram or events. Additionally, it should be appreciated that method 300 disclosed in this specification is capable of being stored on an article of manufacture (e.g., a computer program accessible from any computer-readable device or storage media) to facilitate transporting and transferring such method to computing devices. The term “article of manufacture,” as used herein, is intended to encompass a computer program accessible from any computer-readable device or storage media.

At operation 310, processing logic receives security data from a computing resource. The security data can include one or more of telemetry data, context data, change log data, etc. The security data can be received from one or more computing resources. In some implementations, the security data can include one or more indicators of which computing resource sent the security data (e.g., key data, ID data, etc.).

At operation 315, processing logic determines the security data type. For example, the processing logic can determine whether the security data is payload data (e.g., telemetry data and/or context data), change log data, etc. The processing logic can determine the security data type using, for example, metadata appended to the security data, located in the header of the transmission packet, etc. Responsive to the security data being change log data, the processing logic proceeds to operation 320. Responsive to the security data being payload data, the processing logic proceeds to operation 325.

At operation 320, processing logic stores the change log data in a table related to the corresponding payload data table. The corresponding payload data can be payload data which the change log data references. In some implementations, processing logic can embed, into an appropriate cell of the change log data row, a horizontal partition boundary. The change log data can be stored on a row adjacent to its related payload data (or adjacent to previously stored change log data related to the payload data). As such, the horizontal partition boundary can be embedded in a location to indicate that a split should not happen between the current row and the above row, that a split should occur below the row storing this change log data, etc.

At operation 325, processing logic stores the payload data in a table related to the computing resource. For example, the processing logic can identify a primary key corresponding to the payload data (e.g., using metadata related to the payload data), and generate a new row on the table.

At operation 330, processing logic embeds one or more horizontal partition boundaries related to the payload data. In some implementations, the horizontal partition boundary can be used to indicate that a split is to be performed (by data store 124) directly above the corresponding row storing the payload data.

FIG. 4 depicts a flow diagram of an example method 400 for performing a horizontal partition of a data table, in accordance with implementations of the present disclosure. Method 400 can be performed by processing logic that can include hardware (circuitry, dedicated logic, etc.), software (e.g., instructions run on a processing device), or a combination thereof. In one implementation, some or all of the operations of method 400 can be performed by one or more components of system 100 of FIG. 1. In some implementations, some or all of the operations of method 400 can be performed by data store 124, as described above.

At operation 410, processing logic detects a partition trigger. The partition trigger is a mechanism (e.g., executable code) used to initiate operations related to the horizontal partition of a data table (e.g., operations 420-440) once a particular condition has been satisfied. In some implementations, the partition trigger can include a threshold criterion being satisfied, such as, for example, the amount of data stored on a node of data store 124 exceeding a threshold value, the number of accesses (e.g., queries, writes, etc.) to a node of data store 124 within a particular timeframe satisfying (e.g., exceeding) a threshold value, etc.

At operation 420, the processing logic identifies a split location of the data table to perform a horizontal partition operation. In some implementations, the processing logic can identify the split location based on a predetermined records (e.g., rows) range. For example, in response to the amount of data stored in the data table exceeding a certain number of records (e.g., “x” records), the processing logic can select a split location between records x/2 and x2+1. In other implementations, other methods of identifying the split location can be used, such as, for example, identifying a location between two sets of records based on how frequently the sets are queried.

At operation 430, processing logic identifies a horizontal partition boundary in relation to the split location. For example, the processing logic can identify the next record with an embedded horizontal partition boundary, a previous record with an embedded horizontal partition boundary, the closest record with a horizontal partition boundary, etc.

At operation 440, processing logic performs a horizontal partition operation in relation to the identified horizontal partition boundary. For example, the processing logic can perform a horizontal partition operation above the identified horizontal partition boundary, below the identified horizontal partition boundary, etc. The horizontal partition operation can store the split sets of records on two separate nodes of data store 124.

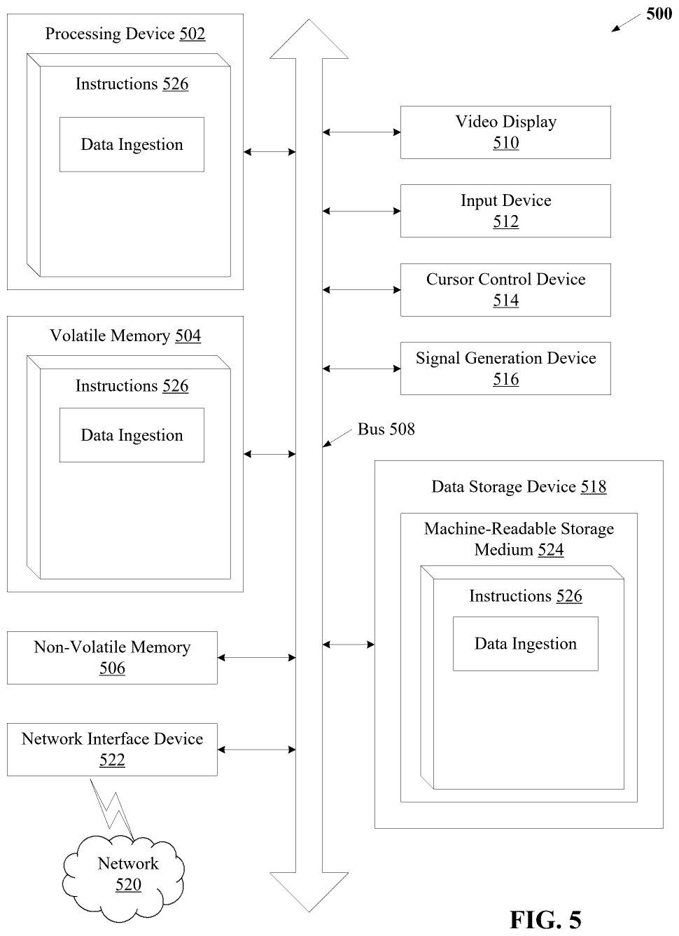

FIG. 5 depicts a block diagram of a computer system operating in accordance with one or more aspects of the present disclosure. In certain implementations, computer system 500 can be connected (e.g., via a network, such as a Local Area Network (LAN), an intranet, an extranet, or the Internet) to other computer systems. Computer system 500 can operate in the capacity of a client device. Computer system 500 can operate in the capacity of a server or a client computer in a client-server environment. Computer system 500 can be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 500 can include a processing device 502, a volatile memory 504 (e.g., random access memory (RAM)), a non-volatile memory 506 (e.g., read-only memory (ROM) or electrically erasable programmable ROM (EEPROM)), and a data storage device 518, which can communicate with each other via a bus 508.

Processing device 502 can be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 500 can further include a network interface device 522. Computer system 500 also can include a video display unit 510 (e.g., an LCD), an input device 512 (e.g., a keyboard, an alphanumeric keyboard, a motion sensing input device, touch screen), a cursor control device 514 (e.g., a mouse), and a signal generation device 516.

Data storage device 518 can include a non-transitory machine-readable storage medium 524 on which can store instructions 526 (e.g., data ingestion instructions) encoding any one or more of the methods or functions described herein, including instructions encoding components of client device of FIG. 1 for implementing methods 300 and 400.

Instructions 526 can also reside, completely or partially, within volatile memory 504 and/or within processing device 502 during execution thereof by computer system 500, hence, volatile memory 504 and processing device 502 can also constitute machine-readable storage media.

While machine-readable storage medium 524 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein can be implemented by discrete hardware components or can be integrated in the functionality of other hardware components such as ASICS, FPGAs, DSPs or similar devices. In addition, the methods, components, and features can be implemented by firmware modules or functional circuitry within hardware devices. Further, the methods, components, and features can be implemented in any combination of hardware devices and computer program components, or in computer programs.

Unless specifically stated otherwise, terms such as “receiving,” “determining,” “sending,” “displaying,” “identifying,” “selecting,” “excluding,” “creating,” “adding,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and cannot have an ordinal meaning according to their numerical designation.

Examples described herein also relate to an apparatus for performing the methods described herein. This apparatus can be specially constructed for performing the methods described herein, or it can comprise a general-purpose computer system selectively programmed by a computer program stored in the computer system. Such a computer program can be stored in a computer-readable tangible storage medium.

The methods and illustrative examples described herein are not inherently related to any particular computer or other apparatus. Various general-purpose systems can be used in accordance with the teachings described herein, or it can prove convenient to construct more specialized apparatus to perform methods 300 and 400 and/or each of its individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A method, comprising:
receiving, by a processing device of a security analytics platform, first data associated with a computing resource;
storing the first data in a first database table associated with the computing resource;
generating a first set of indicators associated with the first database table, wherein each indicator of the first set of indicators identifies a corresponding horizontal partition associated with the first database table;
receiving second data associated with the computing resource;
storing the second data in a second database table associated with the first database table;
generating a second set of indicators associated with the second database table, wherein each indicator of the second set of indicators specifies a corresponding horizontal partition associated with the second database table; and
storing, based on the first set of indicators and the second set of indicators, a first partition of the first database table and a corresponding second partition of the second database table on a same database node.

2. The method of claim 1, wherein the first data comprises telemetry data.

3. The method of claim 2, wherein the second data comprises change log data associated with the telemetry data.

4. The method of claim 1, further comprising:
responsive to detecting a partition trigger, identifying a split location to perform a horizontal partition operation on the database node.

5. The method of claim 1, wherein at least one indicator of the set of indicators is stored in a column associated with the first database table.

6. The method of claim 1, wherein the first set of indicators is generated in response to determining a data type of the first data.

7. The method of claim 1, wherein the first set of indicators is generated based on time data.

8. The system, comprising
a memory; and
a processing device, coupled to the memory, configured to perform operations comprising:
receiving, by a security analytics platform, first data associated with a computing resource;
storing the first data in a first database table associated with the computing resource;
generating a first set of indicators associated with the first database table, wherein each indicator of the first set of indicators identifies a corresponding horizontal partition associated with the first database table;
receiving second data associated with the computing resource;
storing the second data in a second database table associated with the first database table;
generating a second set of indicators associated with the second database table, wherein each indicator of the second set of indicators specifies a corresponding horizontal partition associated with the second database table; and
storing, based on the first set of indicators and the second set of indicators, a first partition of the first database table and a corresponding second partition of the second database table on a same database node.

9. The system of claim 8, wherein the first data comprises telemetry data.

10. The system of claim 9, wherein the second data comprises change log data associated with the telemetry data.

11. The system of claim 8, wherein the operations further comprise:
responsive to detecting a partition trigger, identifying a split location to perform a horizontal partition operation on the database node.

12. The system of claim 8, wherein at least one indicator of the set of indicators is stored in a column associated with the first database table.

13. The system of claim 8, wherein the first set of indicators is generated in response to determining a data type of the first data.

14. The system of claim 8, wherein the first set of indicators is generated based on time data.

15. A non-transitory computer-readable medium comprising instructions that, responsive to execution by a processing device, cause the processing device to perform operations comprising:
receiving, by a security analytics platform, first data associated with a computing resource;
storing the first data in a first database table associated with the computing resource;
generating a first set of indicators associated with the first database table, wherein each indicator of the first set of indicators identifies a corresponding horizontal partition associated with the first database table;
receiving second data associated with the computing resource;
storing the second data in a second database table associated with the first database table;
generating a second set of indicators associated with the second database table, wherein each indicator of the second set of indicators specifies a corresponding horizontal partition associated with the second database table; and
storing, based on the first set of indicators and the second set of indicators, a first partition of the first database table and a corresponding second partition of the second database table on a same database node.

16. The non-transitory computer readable storage medium of claim 15, wherein the first data comprises telemetry data.

17. The non-transitory computer readable storage medium of claim 16, wherein the second data comprises change log data associated with the telemetry data.

18. The non-transitory computer readable storage medium of claim 15, wherein the operations further comprise:
responsive to detecting a partition trigger, identifying a split location to perform a horizontal partition operation on the database node.

19. The non-transitory computer readable storage medium of claim 15, wherein at least one indicator of the set of indicators is stored in a column associated with the first database table.

20. The non-transitory computer readable storage medium of claim 15, wherein the first set of indicators is generated in response to determining a data type of the first data.
